(19) United States
(12) Patent Application Publication
(10) Pub. No.: US 2004/0124167 A1
(43) Pub. Date: Jul. 1, 2004

(54) Mobile crane with elongated boom

(75) Inventor: Hans-Dieter Willim, Ulm-Unterweiler (DE)

Correspondence Address: ROCCO S. BARRESE, ESQ., DILWORTH & BARRESE, LLP, 333 Earle Ovington Blvd., Uniondale, NY, 11553, US

(73) Assignee: Liebherr-Werk Ehingen GmbH

(21) Appl. No.: 10/730,402

(22) Filed: Dec. 8, 2003

(30) Foreign Application Priority Data
Dec. 6, 2002 (DE) 202 18 971.6

(51) Int. Cl. B66C 23/42

(52) U.S. Cl. 212/300

(57) ABSTRACT

The invention concerns a mobile crane with a long main boom. According to the invention, the main boom is in two parts linked at a swivel point in such manner that the boom can bend when raised and can be positioned in extended or quasi-extended final erection position.

The invention concerns a mobile crane with an elongated boom.

Longer and longer booms are being required in special applications. The problem of raising very long booms arises particularly in connection with the erecting of wind generators. Booms of this type are usually raised with an extension derrick boom with attached derrick ballast. However, this is very time-consuming, and in the difficult terrain in which wind generators are often located it is very difficult to do.

Theoretically it is already known how to equip main booms with rocking grid tips. In rocking tips of this type, retainer devices must be provided. Furthermore, after the main boom is raised, they are usually in a bent position in relation to the main boom.

It is the task of the within invention now to permit the erecting of very long main booms without a derrick boom, whereby the entire erection procedure is made easier and in particular long main booms can be raised.

According to the invention, this task is performed by means of the characteristics of claim 1, according to which the main boom is in two parts connected with each other at a swivel point in such manner that the main boom can be bent during erection in order to be moved into an extended or quasi-extended final erection position. This raised main boom does not require any retainer device.

Preferably there is on the main boom a special adaptor with at least one strut member that is positioned to swivel on a swivel point. This adaptor can be positioned at any desired location on the boom.

An outward-swiveling support can be jointed on the strut member.

The mobile crane can have an auxiliary coil off and on which an auxiliary guy can be wound.

Additionally, there can be an adjustment coil over which an adjustment strap can be drawn to the tip of the strut member, which it can be attached by means of a hook.

The adjustment strap can be drawn over this adjustment coil to raise the bent front section of the main boom.

Preferably, two strut members can be positioned parallel to each other.

The swivel axles of the two strut members can be positioned on an oblique in relation to the main boom, in which case by means of the oblique arrangement of the swivel axles of the two strut members a lateral guying can be achieved that further increases the lateral stability of the boom.

Additional details and advantages of the invention are explained in greater detail by means of the embodiment illustrated in the drawing, which shows:

FIG. 1: A side view of a mobile crane according to the within invention, with a main boom still lying on the ground,

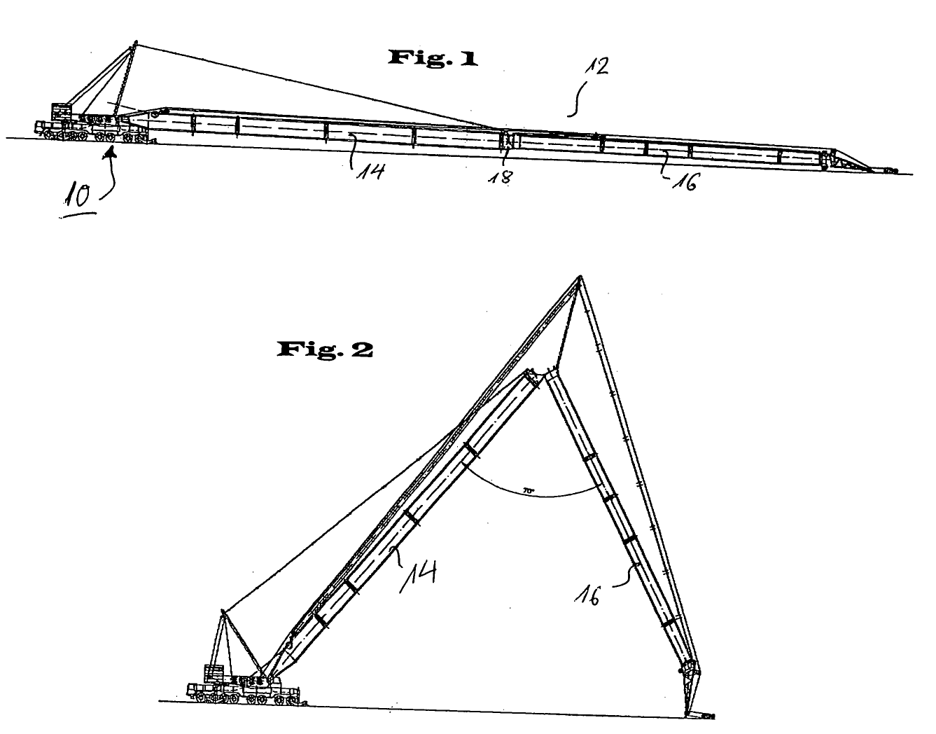

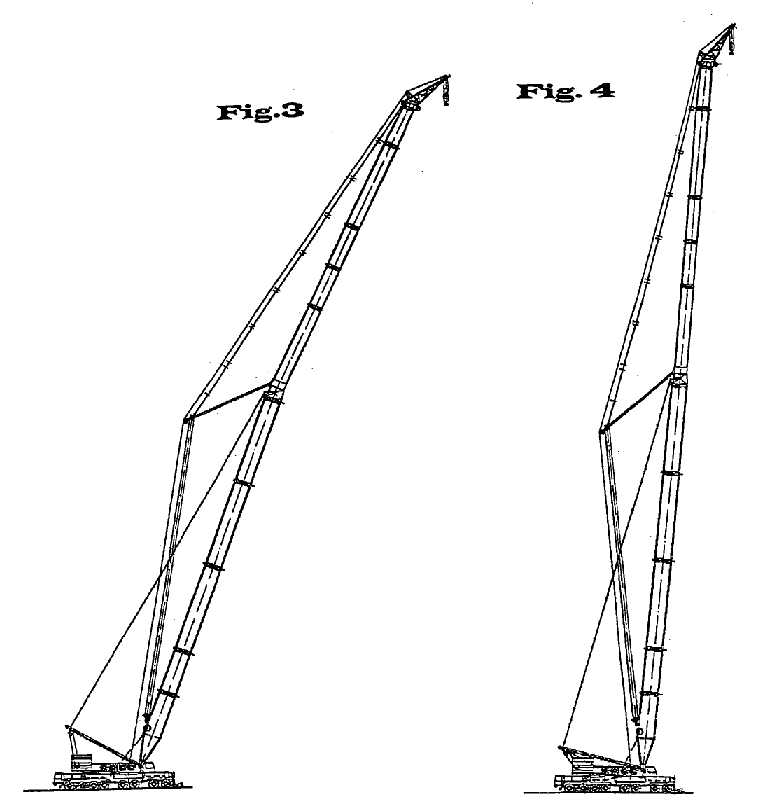

FIGS. 2 to 4: Various working sections during the raising of the main boom in an embodiment as illustrated in FIG. 1,

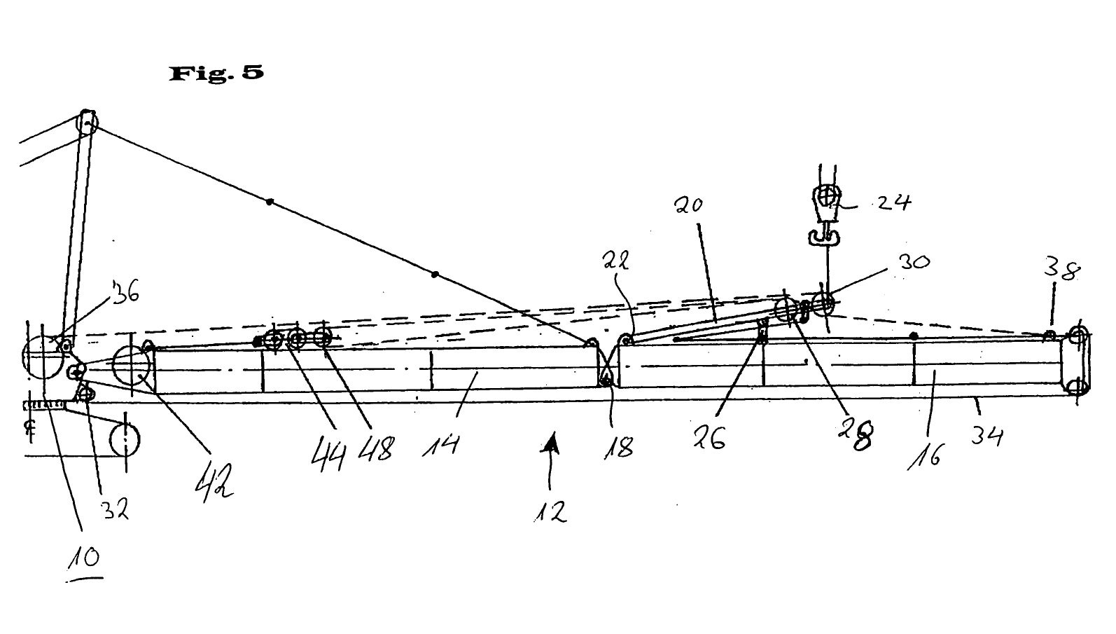

FIGS. 5 to 7: Details during the erection of the mobile crane.

FIG. 1 shows a mobile crane 10 with a main boom 12 consisting of a lower boom segment 14 and an upper boom segment 16, which are connected so as to swivel on a coupling point 18. In FIG. 1 the entire boom length of the main boom 12 is assembled on the ground. This main boom has a special adaptor that is equipped with a knee joint and a strut member and which is installed in the place of a standard adaptor. This adaptor can be installed at any desired point on the boom.

The assembly of the crane and the mobile crane 10 components necessary for the raising of main boom 12 are explained in greater detail by means of FIGS. 5 to 7.

FIG. 5 shows that there is a strut member on the upper segment of main boom 16, which said strut member 20 can pivot on a coupling joint 22 toward upper boom 16. When the main boom is raised, auxiliary crane 24 raises strut member 20 slightly out of transportation position, until a lever arm is created with respect to coupling joint 22. By means of a fold-out support 26 the strut member 20 is held in this position. Two rollers 28 and 30 are positioned at the tip of strut member 20.

There is on mobile crane 10 an auxiliary coil 32 over which an auxiliary guy 34 is drawn and led backward, as partially indicated by the dotted lines in FIG. 5, to a hoist 36. Here auxiliary guy 34 is connected with a hoisting cable wound on the hoist. With auxiliary coil 32, by means of auxiliary guy 34, the hoist is pulled forward to attachment point 38 near the tip of upper segment 16 of main boom 12. There the hoist is bolted to fixed point 38.

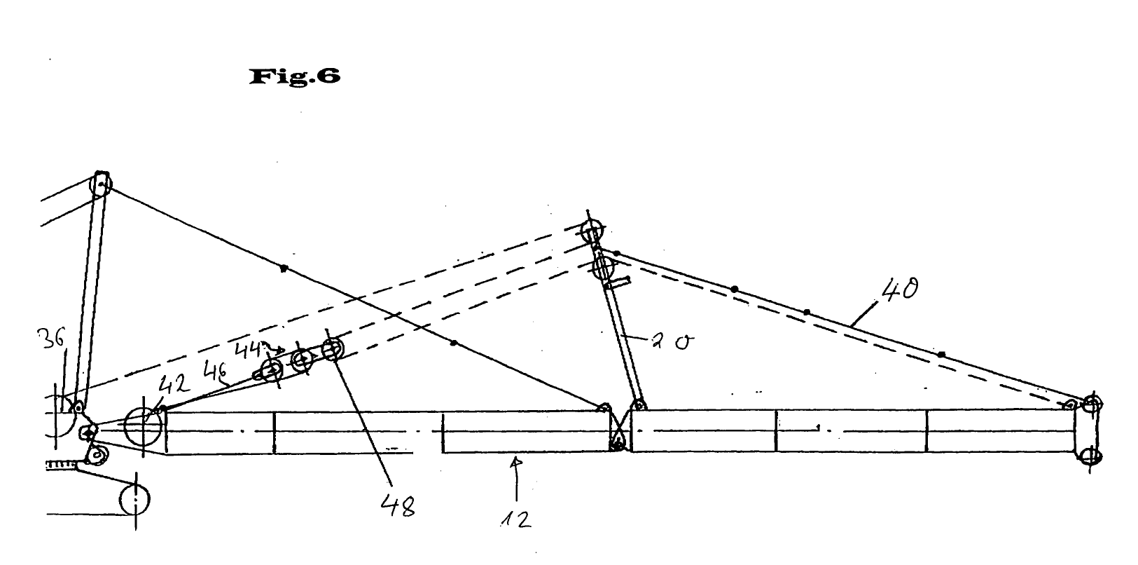

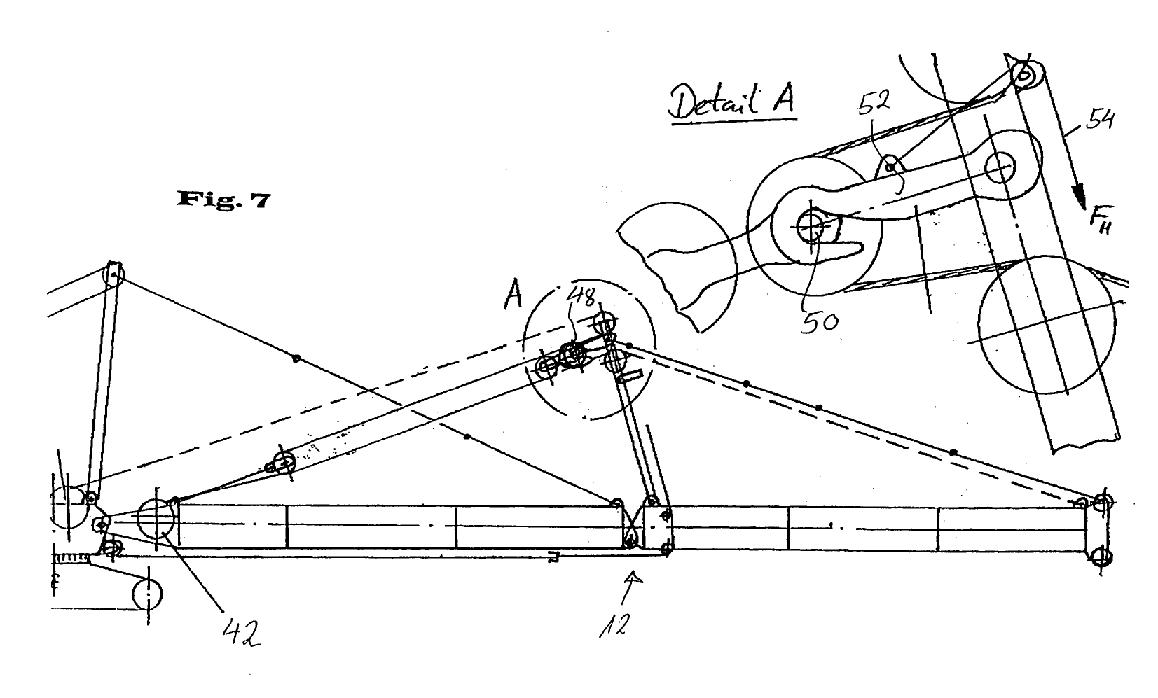

FIG. 6 shows the raising of strut member 20. Through the winding of the hoisting cable on hoist 36, the strut member 20 is straightened independently and guys front anchoring rod 40. An adjustment coil 42, with which an adjustment strap 44 is connected, is positioned on main boom 12. Through the winding of an adjustment cable 46 off adjustment coil 42, and the simultaneous winding up of hoist 36, the upper adjustment strap 48 is drawn to the tip of the strut member, until a pin 50 at the upper adjustment strap 48 engages in a hook 52 (compare FIG. 7 and particularly Detail A on FIG. 7).

For disassembly, hook 52 can be raised with a short auxiliary guy 54 (compare Detail A in FIG. 7). The short auxiliary guy 54 is additionally connected with the long auxiliary guy 34, so that the necessary force can be brought to bear on auxiliary coil 32.

When the main boom is raised, as shown in FIGS. 2 to 4, the lower segment 14 of the main boom is raised first (compare FIG. 2). The tip of the upper segment of boom 16 thereupon rolls on the ground, or is held in suspension with an auxiliary crane. During the raising of lower segment 14 of main boom 12, adjustment strap 44 is continually slackened, so that the boom head weight lies on the ground and therefore does not have to be raised with lower segment 14. After the lower segment of the main boom has reached an appropriate angle to the ground, with consequent displacement of the loads closer to the crane, upper segment 16 of the main boom is pulled up by the pulling of the adjustment strap 44 by means of adjustment coil 42. The main boom is still inclined forward, so that the boom can be moved into an extended position without any need for a retainer device. The boom is drawn up to a stop device and adjustment strap 44 is secured. The stability of boom 10 is further increased by means of this additional guying.

1. Mobile crane with a long main boom,
characterized by the fact that
the main boom is in two parts linked at a swivel point in such manner that the boom can bend when raised and can be positioned in extended or quasi-extended final erection position.

2. Mobile crane according to claim 1, characterized by the fact that at least one strut member is positioned to swivel on a swivel joint.

3. Mobile crane according to claim 2, characterized by the fact that a fold-out support is coupled to the strut member.

4. Mobile crane according to one of claims 1-3, characterized by the presence of an auxiliary coil on or off which an auxiliary guy can be wound or unwound.

5. Mobile crane according to one of claims 14, characterized by the additional presence of an adjustment coil over which an adjustment strap is drawn to the tip of the strut member, where it can be fastened via a hook.

6. Mobile crane according to one of claims 1-5, characterized by the fact that two strut members are positioned parallel to each other.

7. Mobile crane according to claim 6, characterized by the fact that the swivel axles of the two strut members are in an oblique position in relation to the main boom.

8. Mobile crane according to one of claims 5-7, characterized by the fact that the adjustment strap can be drawn over the adjustment coil to raise the bent forward segment of the main boom.
